(19) United States
(12) Patent Application Publication
(10) Pub. No.: US 2013/0140167 A1
(43) Pub. Date: Jun. 6, 2013

(54) TRIGGER SWITCH

(71) Applicant: OMRON CORPORATION, Kyoto-shi (JP)

(72) Inventor: Minoru KOBAYASHI, Okayama-city (JP)

(73) Assignee: OMRON CORPORATION, Kyoto-shi (JP)

(21) Appl. No.: 13/688,921

(22) Filed: Nov. 29, 2012

(30) Foreign Application Priority Data
Dec. 1, 2011 (JP) 2011-264028

(51) Int. Cl. H01H 13/04

(52) U.S. Cl. CPC H01H 13/04
USPC 200/522

(57) ABSTRACT

Embodiments of the invention provide a trigger switch in which a trigger is pulled into a housing so as to operate a contact mechanism, thereby driving a motor of an electric drill. The inside of the housing is divided into a first region including a circuit in which a main electric current for driving the motor flows, and a second region including the contact mechanism of a signal circuit which controls a rotation of the motor. An air vent is disposed on an outer circumferential surface of the first region of the housing. The trigger switch can reduce operational failure due to dust and the like without making the structure thereof complicated.

### BACKGROUND OF THE INVENTION

1. Technical Field

The present invention relates to a trigger switch which is used for an electric tool and the like.

2. Related Art

Conventionally, a trigger switch is used for an electric tool and the like. Such an electric tool is used for cutting an object, and/or drilling the same so that dust and the like tend to be scattered during its usage. The scattered dust and the like tend to enter the inside of the trigger switch due to air flow into and out of the inside of the trigger switch which is caused by trigger operations and the like. The dust and the like, which have entered the inside of the trigger switch, cause negative effects on a mechanism of the trigger switch or a contact and the like.

Then, a variety of measures are taken for preventing the negative effects of the dusts and the like on the mechanism of the trigger switch or the contact and the like. For example, Japanese Unexamined Patent Publication No. 2011-65767 (which was published on Mar. 31, 2011) discloses a technology which suppresses the air flow into and out of the inside of the trigger switch which is caused by the trigger operations. In Japanese Unexamined Patent Publication No. 2011-65767, there is disclosed a gear which changes a linear motion of a trigger into a rotational motion so that a volume change in an inside space of the switch due to the linear motion is prevented, and the air flow into and out of the inside of the switch is suppressed.

However, according to the above-mentioned conventional design, there is needed the mechanism for changing the linear motion into the rotational motion so that the structure thereof is made complicated.

Moreover, when the structure becomes complicated, operational failure is more easily caused by an adhesion of the dust etc. to the concerned portions.

### SUMMARY

The present invention has been devised taking into account the above-mentioned problem, and an objective thereof is to achieve a trigger switch which can reduce the operational failure due to the dust and the like without making its structure complicated.

In accordance with one aspect of the present invention, the trigger switch according to the present invention is a trigger switch for driving a motor of an electric tool, including: a trigger; and a housing including a contact mechanism therein, wherein the trigger is pulled into the housing so that the contact mechanism is operated so as to drive the motor, wherein an inside of the housing is divided into a first region including a circuit in which a main electric current for driving the motor flows, and a second region including the contact mechanism of a signal circuit which controls a rotation of the motor, wherein an air vent is disposed on an outer circumferential surface of the first region of the housing.

The first region is a region including a circuit in which a main electric current for driving the motor, which is driven by a self-trigger switch, flows. The flowing amount of the electric current is large in the circuit in which the main electric current flows so that the occurrence possibility of operational failure due to dust and the like is low. Accordingly, even when the dust and the like flow into this first region, the occurrence possibility of operational failure of the trigger switch is low.

Then, according to the above-mentioned design, the air vent is disposed on the outer circumferential surface of the first region of the housing so that the dust and the like entering the inside of the housing can be guided to the first region. With this, the occurrence possibility of operational failure due to dust and the like can be reduced.

Moreover, embodiments of the present invention have a design in which the contact mechanism is operated by pulling the trigger into the housing so that the trigger switch can be achieved with a simple design. With this, it can be prevented that a complicated design, such as a design in which a mechanism for converting a pulling-in operation into a rotational motion is disposed, so as to increase the influence of the dust and the like.

In the trigger switch according to embodiments of the present invention, the air vent may be disposed at a position which is located in a direction opposite to a direction of a tool portion of the electric tool with respect to a center of the housing.

Usually, the electric tool is used under a state in which the tool portion is positioned above the trigger switch. Accordingly, the surface in the tool portion direction of the housing of the trigger switch, namely, the surface which becomes the upper surface during the normal use, tends to easily receive the dust and the like. According to the above-mentioned design, during the normal use, the air vent is located at a position which is lower than the center of the housing so that the dust and the like accumulated on the upper surface of the housing becomes difficult to enter the air vent. Therefore, the occurrence possibility of the operational failure due to the dust and the like can be reduced.

In the trigger switch according to embodiments of the present invention, the air vent may be disposed on a surface opposite to a surface of the housing where the trigger is pulled-in.

According to the above-mentioned design, the air vent is disposed on a surface opposite to a surface of the housing where the trigger is pulled-in so that the air in the housing can easily flow in and out due to the operation of the trigger.

Moreover, it is often that the trigger and the tool are disposed in the same direction with respect to the housing. Therefore, the air vent is disposed on a surface opposite to a surface of the housing where the trigger is pulled-in so that the inflow amount of the dust and the like can be reduced.

Furthermore, it is often that, in the inside of the electric tool provided with the trigger switch, a support wall is disposed on a surface (opposite surface) opposite to the surface of the housing where the trigger is pulled in. When this support wall is disposed, it is often that only a little dust and the like exist adjacent to the opposite surface. Accordingly, the air vent is disposed on the opposite surface so that the inflow amount of the dust and the like can be reduced.

In the trigger switch according to embodiments of the present invention, the first region may be positioned in a direction opposite to a direction of a tool portion of the electric tool with respect to the second region.

As mentioned above, the electric tool is usually used under a state in which the tool portion is positioned above the trigger switch. Accordingly, the tool portion direction of the electric tool in the housing is the upper direction during the normal use. Therefore, according to the above-mentioned design, the first region is disposed at a position below the second region during the normal use. It is often that the power supply and the connector and the like are disposed at positions which are located in the lower portion of the housing during the normal use. Therefore, the first region can be located closer to the above-mentioned power supply and the connector by disposing the first region on the lower side. With this, an excess wiring can be omitted, and the circuit configuration can be made simple.

### ADVANTAGEOUS EFFECTS

As mentioned above, the trigger switch according to embodiments of the present invention is configured such that the inside of the housing is divided into the first region including the circuit in which the main electric current for driving the motor flows, and the second region including the contact mechanism of the signal circuit which controls the rotation of the motor, and the air vent is disposed on the outer circumferential surface of the first region of the housing.

With this, there can be obtained an advantageous effect that the occurrence possibility of operational failure due to the dust and the like can be reduced.

### BRIEF DESCRIPTION OF THE DRAWINGS

FIGS. 1A to 1D are drawings illustrating appearances of a trigger switch according to an embodiment of the present invention, of which FIG. 1A is a perspective view illustrating an appearance of a trigger switch 1, FIG. 1B is a partially enlarged view of FIG. 1A, FIG. 1C is a cross-sectional view of a part cut from FIG. 1A, and FIG. 1D is a partially enlarged view of FIG. 1C;

FIG. 2 is an exploded perspective view of the above-mentioned trigger switch;

FIG. 3 is an exploded perspective view of the above-mentioned trigger switch;

FIG. 4 a cross-sectional view of a housing portion of the above-mentioned trigger switch which is viewed from a side surface of the housing portion;

FIG. 5 a cross-sectional view of the housing portion of the above-mentioned trigger switch which is viewed from the side surface of the housing portion;

FIGS. 6A and 6B are drawings illustrating a circuit configuration of the above-mentioned trigger switch, of which FIG. 6A illustrates a circuit for signals, and FIG. 6B illustrates a circuit for driving a motor; and

FIGS. 7A to 7C are drawings illustrating situations in which the trigger switch is provided to an electric drill, of which FIG. 7A is a perspective view illustrating the trigger switch which is provided to a casing of the electric drill, FIG. 7B is a side view illustrating the trigger switch which is provided to the casing of the electric drill, and FIG. 7C is a perspective view illustrating the trigger switch which is provided to the casing of the electric drill.

### DETAILED DESCRIPTION

### Design of Trigger Switch 1

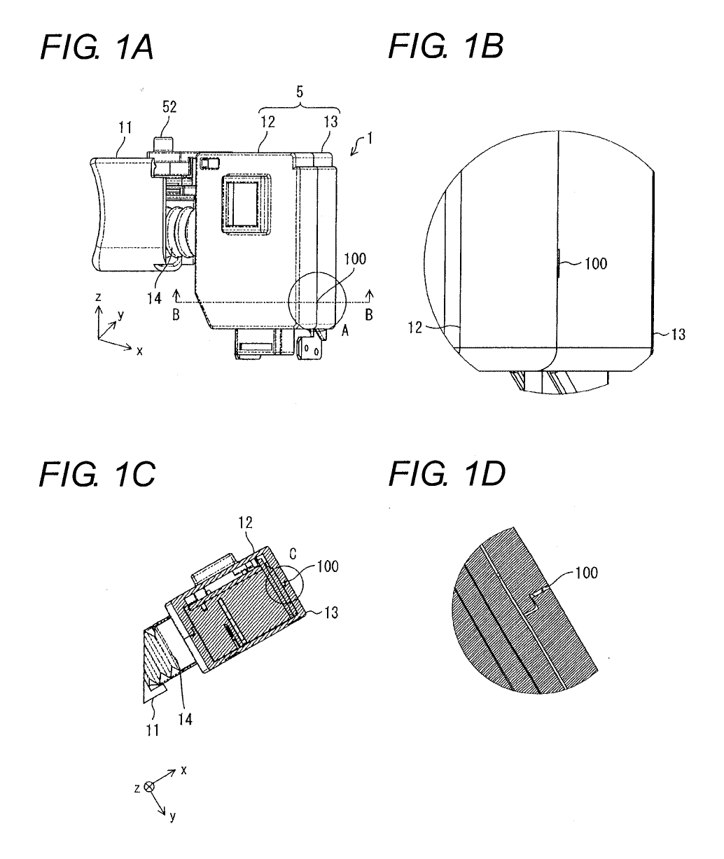

Hereinafter, an embodiment of the present invention will be described with reference to FIGS. 1A to 7C. A trigger switch 1 according to the present embodiment is used by being incorporated into an electric drill and the like. In this embodiment, the direction, in which a trigger 11 of the trigger switch is pressed in, is defined as an x-direction, and the direction of the trigger switch 1, which is upward when a user uses the electric drill, is defined as a z-direction, and the direction, which is perpendicular to the plane formed by the x-direction and the z-direction, is defined as a y-direction. Note that, the z-direction may be called as an upward direction, and the direction opposite to the z-direction may be called as a downward direction.

First, an outline of the trigger switch 1 according to the present embodiment will be described with reference to FIGS. 1A to 1D. FIGS. 1A to 1D are drawings for describing an outline of the trigger switch 1 according to the present embodiment, of which FIG. 1A is a perspective view illustrating an appearance of the trigger switch 1, FIG. 1B is a partially enlarged view of FIG. 1A, FIG. 1C is a cross-sectional view of a part cut from FIG. 1A, and FIG. 1D is a partially enlarged view of FIG. 1C.

The appearance view of FIG. 1A illustrates the trigger 11 of the trigger switch 1, a first cover 12, a second cover 13, a bellows tubular body 14, an operation lever 52, and a breath hole (an air vent) 100. A housing 5 is configured by the first cover 12 and the second cover 13.

Although a detailed structure of the trigger switch 1 will be described later, the housing 5 of the trigger switch 1 is configured such that the breath hole 100 is disposed on the side of −z-direction (downward direction) of the surface (outer circumferential surface) which is opposite to the surface in which the trigger 11 is pressed in (pulled in), and the remaining is covered. With this, the dust and the like flow into the inside of the housing 5 and flow out of the same only through the breath hole 100.

In more detail, the trigger 11 is pressed in (moves in the +x-direction) so that the air existing in the space within the housing 5 is discharged outside the housing 5. On the other hand, the trigger 11 under the state of being pressed-in returns to the initial position (moves in the −x-direction) so that the air existing outside the housing 5 is taken-in into the inside of the housing 5. At this time, the air including the dust and the like is made to enter the inside of the housing 5.

Then, in the inside of the housing 5, the upper side (+z-direction side) corresponds to a region in which a contact of a signal for a rotation control is included (control signal contact region), and the lower side (−z-direction side) corresponds to a circuit region in which a main electric current for a motor drive flows (high capacity circuit region). As mentioned above, the breath hole 100 is disposed on the lower side of the housing 5, namely the high capacity circuit region side. Although a detail will be described later, in the high capacity circuit region, the flowing electric current is so large that a contact failure due to the dust and the like is difficult to occur. On the other hand, in the control signal contact region, the flowing electric current is so small that a contact failure due to the dust and the like is easy to occur. Therefore, the breath hole 100 disposed on the lower side of the housing 5 can guide the dust and the like entering the housing 5 to the high capacity region side so that the occurrence of the operational failure due to the dust and the like can be suppressed to the minimum.

Moreover, the breath hole 100 is disposed on the surface opposite to the surface of the housing 5 where the trigger 11 is pressed-in, so that the internal air in the housing 5 is easy to be discharged when the trigger 11 is pressed-in, thereby capable of providing a smooth operational feeling.

FIG. 1B is an enlarged view of an A portion in FIG. 1A. As illustrated in FIG. 1B, the breath hole 100 is disposed at a position where the first cover 12 and the second cover 13 are combined. Moreover, FIG. 1D is an enlarged view of a cross section which is cut along B-B line in FIG. 1A. As illustrated in FIG. 1D, the breath hole 100 is disposed at a position where the first cover 12 and the second cover 13 are combined, and its structure is a so-called spigot ferrule. With this, the first cover 12 and the second cover 13, which have been combined with each other, are prevented from easily being separated.

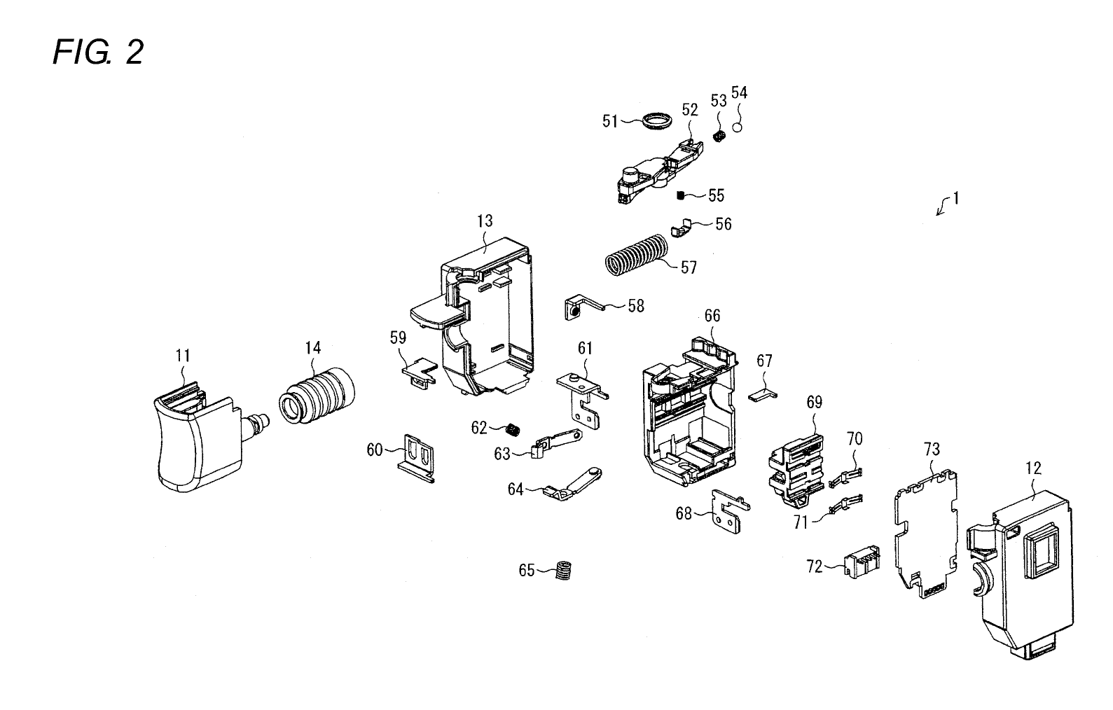

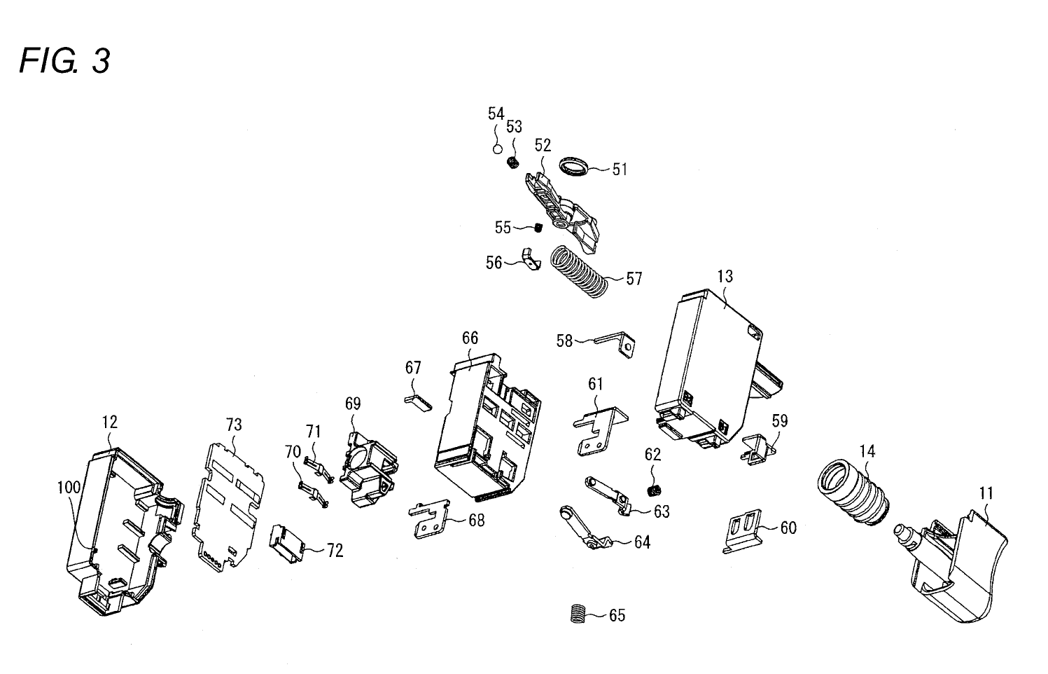

Next, the internal structure of the trigger switch 1 will be described with reference to FIGS. 2 and 3. FIGS. 2 and 3 are exploded perspective views of the trigger switch 1.

As illustrated in FIG. 2, the trigger switch 1 is configured such that internal components, such as a base 66, a plunger 69, a printed circuit board 73 and the like, are incorporated into the housing 5 which is formed by combining the first cover 12 and the second cover 13, and the trigger 11 and an operational lever 52 are assembled.

A first movable contact 63 and a stationary contact terminal 58 are incorporated on the upper side of the base 66, and a second movable contact 64 is incorporated on the lower side of the base 66. Moreover, coil springs 62, 65 for pressing the contacts are assembled in the base 66 so as to respectively support the movable contacts, and bias the contacts in the directions for closing the contacts. Moreover, the first movable contact 63 and the stationary contact terminal 58 are configured to make contact with each other when the trigger 11 is pressed-in to the maximum. Furthermore, common terminals 61, 68 are incorporated in the lower portion surface of the base 66.

The plunger 69 is slidably fitted in the base 66, and a first sliding member 70 and a second sliding member 71 are incorporated in the outward side surface of the plunger 69. Then, the first sliding member 70, which is attached to the outward side surface of the plunger 69, slides along a sliding resistive element (not shown) of the printed circuit board 73 described later so that the resistance value changes.

The printed circuit board 73 has a planar shape which can be contained in the first cover 12 and the second cover 13. The printed circuit board 73 is electrically connected to a connector 72, and has an inward surface on which the sliding resistive element (not shown) is printed. Then, the printed circuit board 73 is positioned at the base 66, in which the plunger 69 is contained, and is integrated with the base 66.

The trigger 11 is configured such that a laterally projecting operational shaft is inserted into the bellows tubular body 14, a cut out groove, which is disposed adjacent to a projecting distal end portion, is slidably engaged the plunger 69, and one end portion of the coil spring 57 for return is fitted into the distal end portion. Then, the coil spring 57 for return biases the trigger 11 and the plunger 69 so as to be pressed outward from the housing 5.

A steel ball 54 is assembled on one end portion of the operational lever 52 via a coil spring 53 for the operational lever so as to be biased outward, and a movable contact 56 for switching is assembled on a lower surface of the one end side via a coil spring 55 for switching. Then, a shaft portion of the operational lever 52 is fitted into a seal rubber 51 so as to be rotatably supported, and is brought into connection with a contact terminal 67 for switching when rotated in one direction. The design of the trigger switch 1 is described above.

(Operation of Trigger Switch 1)

Next, an operation of trigger switch will be described.

First, when the operational lever 52 is located at a neutral position, the one end portion of the operational lever 52 is abutted against a central protruding portion of the trigger 11 so that the trigger 11 cannot be pressed in. With this, operational errors are prevented.

Then, after the operational lever 52 is rotated, and before the trigger 11 is pulled in, the first sliding member 70 makes contact with the sliding resistive element (not shown) of the printed circuit board 73 so as to exhibit the maximum resistance value. Moreover, the first movable contact 63 and the second movable contact 64 are respectively biased by the coil springs 62, 65 for pressing the contacts, but are held down by the plunger 69 at its side opposite to the contact so as to open the contact.

Next, when a user slightly presses the trigger 11 inward, the plunger 69 engaged with the operational shaft which is integral with the trigger 11 is moved to slide. With this, the second movable contact 64 is brought into a contact state so as to create a preparatory state in which an electrical current flows into a motor.

After that, when the trigger 11 is further pressed inward, the first sliding member 70, which is assembled with the plunger 69, slides on the sliding resistive element of the printed circuit board 73 so as to change the resistance so that the motor starts rotating, and the number of revolutions is increased by the change of the resistance.

Furthermore, when the trigger 11 is pressed in, and the operational shaft is pressed into the back side of the base 66, the first movable contact 63 is rotated so as to close the contact, and the maximum electrical current flows so that the number of revolutions of the motor becomes maximum.

After that, when the user reduces the force for pressing-in the trigger 11, the plunger 69 is moved back by the spring force of the coil spring 57 for return so as to return to the initial state, and the number of revolutions of the motor is gradually reduced so as to make the motor stopped.

Moreover, when the operational lever 52 is rotated in a direction opposite to the above-mentioned direction, the rotational direction of the motor is made to be opposite.

Note that, FIG. 3 is an exploded perspective view of the trigger switch 1 similar to FIG. 2, but viewed from a different direction.

(Circuit Configuration)

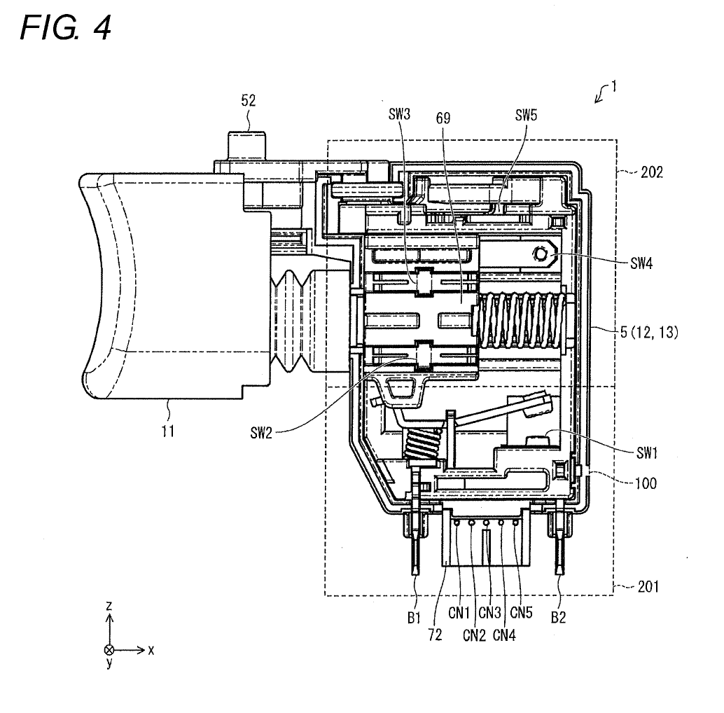

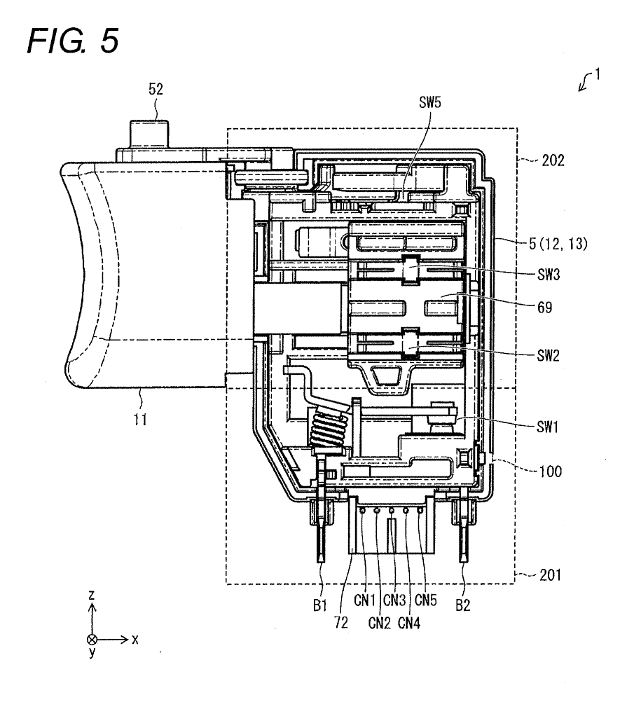

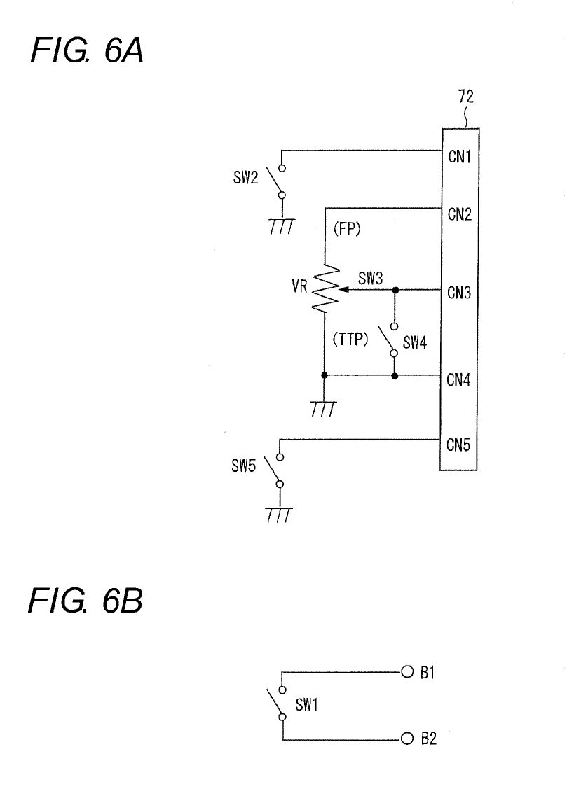

Next, the circuit configuration of the trigger switch 1 will be described with reference to FIGS. 4 to 6B. FIGS. 4 and 5 are cross-sectional views which are viewed from the side surface of the housing 5 of the trigger switch 1, and FIGS. 6A and 6B are drawings illustrating the circuit configurations of the trigger switch 1.

FIG. 4 illustrates a state in which the trigger 11 is not pressed-in. Contacts of the power supply circuit (contact mechanism) are included in the housing 5 as denoted with SW1 to SW5.

The SW1 denotes a power shutdown contact which switches on/off the main electrical current for driving the motor. As illustrated in FIG. 4, the SW1 is disposed at the lower portion of the housing 5. This is because power supplies of electric tools, such as an electric drill, are generally located below the electric tools so that the SW1 is preferably disposed as close to the power supply as possible, and an excess wiring can be omitted when the SW1 is positioned close the connector 72.

When this SW1 is closed, there is created a preparatory state in which an electrical current flows into the motor. The SW1 corresponds to the second movable contact 64 of the components illustrated in FIGS. 2 and 3.

The SW2 is a main contact which switches on/off a power supply of a speed changing circuit in order to change the rotational speed of the motor and the like. As illustrated in FIG. 4, the SW2 is disposed at a portion which is slightly above the center of the housing 5. When this SW2 is closed, the rotational speed of the motor can be made controllable. The SW2 corresponds to the second sliding member 71 of the components illustrated in FIGS. 2 and 3.

The SW3 is a sliding resistance variable contact which can change the sliding resistance for changing the rotational speed of the motor. As illustrated in FIG. 4, the SW3 is disposed above the SW2 of the housing 5. The position of this SW3 is moved so that the rotational speed of the motor is changed. The SW3 corresponds to the first sliding member 70 of the components illustrated in FIGS. 2 and 3.

The SW4 is a full speed contact for making the motor rotated at full rotational speed. As illustrated in FIG. 4, the SW4 is disposed at the upper portion of the housing 5. The SW4 is closed so that the motor is rotated at full rotational speed. The SW4 corresponds to the first movable contact 63 of the components illustrated in FIGS. 2 and 3.

The SW5 is a forward/reverse rotation switching contact for changing the rotational directions of the motor. As illustrated in FIG. 4, the SW5 is disposed at the upper portion of the housing 5. The SW5 is switched so that the rotational direction of the motor is switched. The SW5 is disposed at the lower portion of the operational lever 52 of the components illustrated in FIGS. 2 and 3.

Then, SW1 is the contact for the main electric current used for driving the motor so that the flowing amount of the electric current is large. Approximately, an electric current of 10 A, DC25.2 V, flows, and sometimes, an inrush current of 50 A or more flows. Moreover, the flowing amount of the electric current is large so that, even when an adhesion of the dust and the like occurs, the possibility of occurrence of operational failure is low. In the present embodiment, the lower region of the housing 5, in which this SW1 is included, is called a high capacity circuit region (first region) 201. Namely, the high capacity circuit region 201 is a region where the circuit, in which the main electric current for driving the motor flows, is included.

Moreover, the SW2 to SW5 are contacts of a circuit for signals in order to control the rotation of the motor, and the flowing amount of the electric current is small. Approximately, an electric current of 2 mA, DC5 V (or DC25.2 V) flows therein. Then, the flowing amount of the electric current is small so that, when an adhesion of the dust and the like occurs, the possibility of occurrence of operational failure is high. In the present embodiment, the upper region of the housing 5, in which these SW2 to SW5 are included, is called a circuit region for signals (second region) 202. Namely, the circuit region for signals 202 is a region where the contacts for the signals for controlling the rotation are included.

Then, in the present embodiment, the circuit region for signals 202 is disposed at the upper side (+z-direction side) of the housing 5, and the high capacity circuit region 201 is disposed at the lower side (−z-direction side) of the housing 5. As mentioned above, the circuit region for signals 202 is weak against the dust and the like, and the high capacity circuit region 201 is strong against the dust and the like. Then, the breath hole 100 is disposed on a surface opposite to the trigger 11 of the high capacity circuit region 201.

With this, the dust and the like enter the high capacity circuit region 201 so that the occurrence possibility of operational failure of the trigger switch 1 can be reduced.

Note that, the SW2 is applied with a voltage which is higher than the voltages of the other contacts for signals (SW3 to SW5) so that the SW2 may be disposed adjacent to the high capacity circuit region 201.

Moreover, there may be provided a design in which a partition wall is disposed between the high capacity circuit region 201 and the circuit region for signals 202. The partition wall is disposed so that the dust and the like can be almost completely prevented from entering the circuit region for signals 202, thereby the occurrence possibility of operational failure of the trigger switch 1 can be reduced further.

Moreover, the high capacity circuit region 201 and the circuit region for signals 202 may be defined in accordance with the flowing amounts of the electric currents. For example, the high capacity circuit region 201 may be defined as a region in which an electric current of 1 A or more flows, and the circuit region for signals 202 may be defined as a region in which an electric current of less than 1 A flows.

FIG. 5 is a drawing illustrating a state in which the trigger 11 is pressed in. As illustrated in FIG. 5, when the trigger 11 is pressed in, the internal space of the housing 5 is reduced by the plunger 69. With this, the air existing in the internal space of the housing 5 is discharged outside from the housing 5. In the present embodiment, the air is discharged from the breath hole 100.

On the other hand, when the trigger 11 under the state of being pressed-in is returned to the state of the initial position as illustrated in FIG. 4, the internal space of the housing 5 is enlarged. With this, the air in the outside of the housing 5 enters the inside of the housing 5. The outside air entering the inside of the housing 5 also enters via the breath hole 100.

FIGS. 6A and 6B are drawings illustrating the circuit configurations of the trigger switch 1. FIG. 6A is a drawing illustrating the circuit for signals, and FIG. 6B is a drawing illustrating the circuit for driving the motor. As illustrated in FIG. 6A, the circuit for signals is configured as a circuit including the connector 72 in which connection points CN1 to CN5 are disposed. The SW2 is a main switch, the SW5 is a selector switch, the SW3 is a variable resistance switch, and the SW4 is a short circuiting switch. Moreover, as illustrated in FIG. 6B, the SW1 is a power switch of the circuit for driving the motor.

(State in which Trigger Switch 1 is provided to Electric Drill 10)

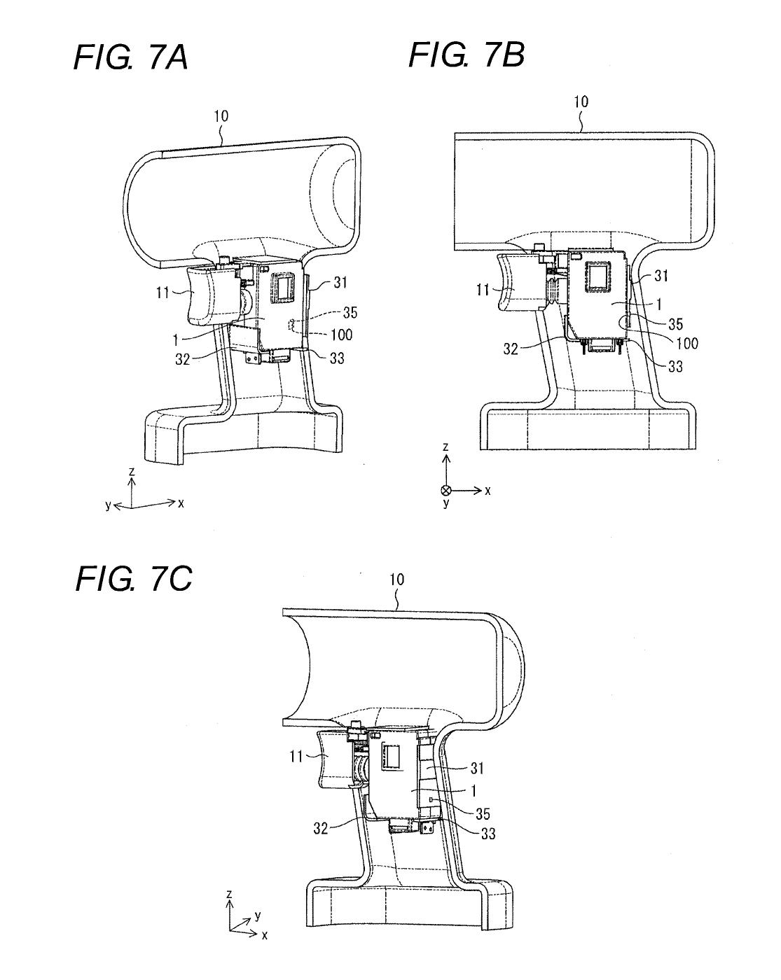

Next, there is described a state in which the trigger switch 1 is provided to the electric drill 10 with reference to FIGS. 7A to 7C. FIGS. 7A to 7C are drawings illustrating a state in which the trigger switch 1 is provided to the electric drill 10. FIG. 7A is a perspective view illustrating the trigger switch 1 which is provided to the casing of the electric drill 10, FIG. 7B is a side view illustrating the trigger switch 1 provided to the casing of the electric drill 10, and FIG. 7C is a perspective view illustrating the trigger switch 1 provided to the casing of the electric drill 10.

Although FIGS. 7A to 7C don't illustrate a detailed design of the electric drill 10, and a drill portion thereof, the drill portion is disposed on the upper side (+z-direction side) of the trigger switch 1. Then, as illustrated in FIGS. 7A to 7C, the trigger switch 1 is provided to the central portion of the electric drill 10 which is to be grasped by a user. In other words, the trigger 11 of the trigger switch 1 is disposed at a position where a finger of the user is just reached.

Moreover, the trigger switch 1 is incorporated so as to rest on ribs 32, 33 for positioning which are disposed in the electric drill 10, and a support wall 31 of the trigger switch 1 is disposed on an opposite surface (+x-direction surface) of the trigger switch 1. Furthermore, a hole 35 having the same size as that of the breath hole 100 is disposed at a position of the support wall 31 corresponding to the breath hole 100.

The support wall 31 is disposed on the +x-direction side of the trigger switch 1 so that only a little dust and the like exist on the surface (opposite surface) opposite to the surface of the housing 5 into which the trigger 11 is pressed. Accordingly, the breath hole 100 is disposed on the above-mentioned opposite surface so that the breath hole 100 can reduce the amount of the dust and the like which enter the inside of the housing 5.

### Advantageous Effects

As mentioned above, the trigger switch 1 according to the present embodiment has the design in which the breath hole 100 is disposed at the lower portion (−z-direction side) of the surface on the side (+x-direction side) opposite to the trigger 11 of the housing 5. Moreover, in the housing 5, the circuit region for signals 202 is disposed on the upper side, and the high capacity circuit region 201 is disposed on the lower side.

With this, the dust and the like, which enter the housing 5 due to the operations of the trigger 11 and the like, can be guided to the high capacity circuit region 201 side in the housing 5. Note that, the operational failure due to the dust and the like is difficult to occur in the high capacity circuit region 201. Accordingly, the occurrence of the operational failure of the trigger switch 1 due to the dust and the like can be reduced.

Moreover, the trigger switch 1 according to the present embodiment does not have a mechanism for converting a linear motion of the trigger 11 into a rotational motion so as to be a simple mechanism. Therefore, it can be prevented that a complicated mechanism increases the possibility of being affected by the dust and the like.

Moreover, in the trigger switch 1 according to the present embodiment, the breath hole 100 is disposed on the surface opposite to the trigger 11 of the housing 5. With this, the air in the housing 5 can be easily discharged when the trigger 11 is operated so that the operational feeling of the trigger 11 can be improved.

Moreover, in the trigger switch 1 according to the present embodiment, the high capacity circuit region 201 is disposed on the lower side of the housing 5. With this, the high capacity circuit region 201 can be disposed adjacent to the power supply and the connector so that an excess wiring and the like can be reduced, thereby capable of simplifying the circuit configuration.

The present invention is not limited to the above-mentioned embodiment, and can be variously modified within the scope of the claims. Namely, the technical scope of the present invention covers an embodiment which can be obtained by combining technical means which are suitably changed within the scope of the claims.

### INDUSTRIAL APPLICABILITY

The trigger switch is strong against the dust and the like so as to be suitable for an electric tool which is used in a place where the dust and the like are easily generated, such as an electric drill.

There has thus been shown and described a novel trigger switch using the same which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A trigger switch for driving a motor of an electric tool, comprising:
a trigger; and
a housing including a contact mechanism therein,
wherein the trigger is disposed so that when it is pulled into the housing, the contact mechanism is operated so as to drive the motor,
wherein an inside of the housing is divided into
a first region including a circuit in which a main electric current for driving the motor flows; and
a second region including the contact mechanism of a signal circuit which controls a rotation of the motor,
wherein an air vent is disposed on an outer circumferential surface of the first region of the housing.

2. The trigger switch according to claim 1, wherein the air vent is disposed at a position which is located in a direction opposite to a direction of a tool portion of the electric tool with respect to a center of the housing.

3. The trigger switch according to claim 1, wherein the air vent is disposed on a surface opposite to a surface of the housing where the trigger is pulled-in.

4. The trigger switch according to claim 2, wherein the air vent is disposed on a surface opposite to a surface of the housing where the trigger is pulled-in.

5. The trigger switch according to claim 1, wherein the first region is positioned in a direction opposite to a direction of a tool portion of the electric tool with respect to the second region.

6. The trigger switch according to claim 2, wherein the first region is positioned in a direction opposite to a direction of a tool portion of the electric tool with respect to the second region.

7. The trigger switch according to claim 3, wherein the first region is positioned in a direction opposite to a direction of a tool portion of the electric tool with respect to the second region.
